(19) United States
(12) Patent Application Publication
(10) Pub. No.: US 2004/0260017 A1
(43) Pub. Date: Dec. 23, 2004

(54) Inverter mixtures for polymer dispersions with improved environmental impact

(76) Inventors: Richard Mertens, Krefeld (DE); Klaus Zimmermann, Rodenbach (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/492,633

(22) PCT Filed: Sep. 16, 2002
(86) PCT No.: PCT/EP02/10348

(30) Foreign Application Priority Data
Oct. 19, 2001 (DE) 101 51 187.6

(51) Int. Cl. C08J 3/00

(52) U.S. Cl. 524/832

(57) ABSTRACT

The present invention relates to an inverter mixture, containing at least one ethoxylated fatty alcohol and at least one ethoxylated fatty acid mono- and/or dialkanolamide, or at least one ethoxylated fatty alcohol and at least one alkylpolyglycoside. Said invention also relates to the use of said inverter mixtures as additives in water-in-oil polymer dispersions as well as to the water-in-oil polymer dispersions themselves, which contain said inverter mixtures and to the use of said water-in-oil polymer dispersions as flocculants, thickeners, carriers for agricultural chemicals or as anti-erosion agents.

The present invention relates to an inverter mixture which contains at least one ethoxylated fatty alcohol and at least one ethoxylated fatty acid mono- and/or dialkanolamide or at least one ethoxylated fatty alcohol and at least one alkylpolyglycoside.

The present invention furthermore relates to the use of the inverter mixtures according to the invention as an addition to water-in-oil polymer dispersions and to water-in-oil polymer dispersions themselves which contain such inverter mixtures and to the use of the water-in-oil polymer dispersions as flocculants, thickeners, supports for agrochemicals or as antierosion agents.

Water-in-oil polymer dispersions have many applications, for example as flocculants for settling solids, in particular in water and process water treatment or waste water treatment, in the extraction of raw materials, for example of coal, aluminium and petroleum or as auxiliaries in papermaking and in the sugar industry. Since, in certain applications, for example when used as an addition to fire-extinguishing, phytosanitary or antierosion agents, these polymer dispersions are frequently used in the natural environment, the ecotoxicological properties of such dispersions are of ever greater significance and currently available products often fail adequately to meet such requirements.

In general, the water-in-oil dispersion must be inverted before or during use into an oil-in-water dispersion. This is achieved by adding inverting emulsifiers (“inverters”) which ensure the wettability of the polymer-containing micelles by a continuous aqueous phase. Ethoxylated fatty alcohols are conventionally used for this purpose, such as for example Marlipal® O 13/50, an isodecanol ethoxylated with 5 mol of EO, distributed by Condea.

One disadvantage of ethoxylated fatty alcohols is that they are comparatively toxic to daphnia and so distinctly impair the ecotoxicological properties of the finished product. Other, ecotoxicologically safe surfactants such as for example ethoxylated fatty acid ethanolamides or alkylpolyglycosides are mainly unsuitable as inverting emulsifiers because their solubilising properties in the water-in-oil polymer dispersion are inadequate and/or they bring about excessive thickening of the dispersion.

The object therefore arose of providing an inverter mixture which

exhibits comparatively low ecotoxicity,

is sufficiently dispersible or soluble in water-in-oil polymer dispersions and

the addition of which to polymer dispersions gives rise to product viscosities which permit the use of said polymer dispersions as an addition to fire extinguishing, phytosanitary or antierosion agents or as flocculating auxiliaries, retention agents or dehydrating agents.

Said object has been achieved by the provision of an inverter mixture which contains at least one ethoxylated fatty alcohol and at least one ethoxylated fatty acid mono- and/or dialkanolamide or at least one ethoxylated fatty alcohol and at least one alkylpolyglycoside.

The inverter mixture preferably comprises at least one ethoxylated fatty alcohol, at least one ethoxylated fatty acid mono- and/or dialkanolamide and at least one alkylpolyglycoside.

The person skilled in the art understands that, for the purposes of the invention, fatty alcohol, fatty acid mono- and/or dialkanolamide and alkylpolyglycoside may also comprise a mixture of two or more substances from the same class.

Preferably, the ratio of ethoxylated fatty alcohol to ethoxylated fatty acid mono- and/or dialkanolamide or to alkylpolyglycoside is from 1:10 to 10:1, preferably 1:3 to 3:1. The proportion of ethoxylated fatty acid mono- and/or dialkanolamide in the mixture generally falls as the degree of ethoxylation rises.

The inverter mixture preferably contains at least one ethoxylated fatty alcohol which is linear or branched and the alkyl chain of which comprises 8 to 30, preferably 8 to 22, particularly preferably 12 to 18 and very particularly preferably 10 to 15 carbon atoms.

An ethoxylation product of at least one highly crosslinked fatty alcohol is likewise preferably used in the mixtures according to the invention, said products being obtainable by oxo synthesis, such as for example isotridecyl alcohol. Ethoxylation products of higher, singly branched fatty alcohols which are obtainable by the Guerbet reaction are particularly preferred.

In a preferred embodiment, the inverter mixture contains at least one ethoxylated fatty alcohol, which is ethoxylated with 1 to 20 mol, preferably 2 to 12 mol, particularly preferably 3 to 8 mol of EO.

Very particularly preferred inverter mixtures are those containing at least one ethoxylated fatty alcohol which comprises 10 to 15, preferably 12 to 14, particularly preferably 13 carbon atoms and is ethoxylated with 3 to 8 mol of EO.

Another preferred inverter mixture is that which contains at least one ethoxylated fatty acid mono- and/or dialkanolamide, the fatty acid moiety of which comprises 6 to 22, preferably 10 to 18, particularly preferably 12 to 14 carbon atoms.

Inverter mixtures which contain at least one ethoxylated fatty acid monoethanolamide which is ethoxylated with 0 to 22 mol, preferably 4 to 13 mol of EO, are also preferred.

A further preferred inverter mixture is that which contains at least one alkylpolyglycoside, the alkyl moiety of which comprises 6 to 22, preferably 6 to 16, particularly preferably 8 to 12 carbon atoms.

The inverter mixtures according to the invention exhibit low ecotoxicity. The inverter mixtures according to the invention are sufficiently dispersible or soluble in water-in-oil polymer dispersions and increase the viscosity thereof only insignificantly. This increase in product viscosity may be counteracted by modifying the ratio of oil to water in the dispersion.

Using the inverter mixtures according to the invention, it is possible to produce polymer dispersions whose product viscosity after activation is in the range from 100-1000 mPa·s, measured with a Brookfield viscosimeter, and which are completely wettable or soluble or swollen in water within a short time, for example within 8-15 seconds. Such polymer dispersions may for example be used as thickeners for fire extinguishing water.

Another aspect of the present invention relates to the use of the inverter mixture according to the invention as an addition to water-in-oil polymer dispersions.

The inverter mixture is preferably added in a quantity of 0.5 to 10 wt. %, particularly preferably 2 to 8 wt. %, very particularly preferably 3 to 6 wt. %, relative to the total quantity of the water-in-oil polymer dispersion.

The inverter mixture is preferably used for converting a water-in-oil polymer dispersion into an oil-in-water polymer dispersion by the addition of large quantities of water.

The inverter mixture is readily miscible with the water-in-oil polymer dispersions and increases the viscosity of the resultant product only slightly. The polymer dispersions exhibit low ecotoxicity.

The present invention also provides water-in-oil polymer dispersions consisting of a continuous, virtually water-immiscible organic phase and, finely dispersed therein, water-soluble and/or water-swellable polymers and optionally auxiliary substances, said dispersions containing an inverter mixture according to the invention.

A water-in-oil polymer dispersion for the purposes of the invention comprises not only a polymer emulsion but also a polymer suspension, as is described, for example, in Ullmann's Encyclopedia of Industrial Chemistry, 1988, vol. All, page 254, which is hereby introduced as a reference and is thus deemed to be part of the disclosure.

The water-in-oil polymer dispersions preferably consist of:

A) 10 to 70 wt. %, preferably 20 to 50 wt. %, particularly preferably 25 to 35 wt. %, of a water-soluble and/or water-swellable polymer,

B) 20 to 80 wt. % of an organic phase,

C) 0.5 to 10 wt. % of a water-in-oil emulsifier,

D) optionally 0.01-2 wt. % of a residual monomer scavenger,

E) 0.5 to 10 wt. % of the inverter mixture, and

F) water to make up to 100 wt. %.

The polymers contained in the water-in-oil polymer dispersions according to the invention comprise a class of products which are produced by reversed-phase emulsion polymerisation. In this method, finely dispersed water-soluble and/or water-swellable polymers are produced in a continuous, virtually water-immiscible organic phase with addition of water-in-oil-emulsifiers.

The polymers are produced by adding the monomers to the organic phase as a monomer solution consisting of water and suitable monomers. The aqueous monomer solution contains at least one polymerisable, hydrophilic monomer. Said solution may, however, also consist of a mixture of two or more monomers from the group of hydrophilic monomers.

Hydrophilic, preferably water-soluble monomers are, for example

olefinically unsaturated carboxylic acids and carboxylic anhydrides, in particular acrylic acid, methacrylic acid, itaconic acid, crotonic acid, glutaconic acid, maleic acid and maleic anhydride and the water-soluble salts thereof,

olefinically unsaturated sulfonic acids, in particular aliphatic or aromatic vinylsulfonic acids, such as for instance vinylsulfonic acid, allylsulfonic acid, styrenesulfonic acid, in particular acrylic and methacrylic sulfonic acids, such for instance sulfoethyl acrylate, sulfoethyl methacrylate, sulfopropyl acrylate, sulfopropyl methacrylate, 2-hydroxy-3-methacryloxypropylsulfonic acid and 2-acrylamido-2-methylpropanesulfonic acid (AMPS) and the preferably water-soluble salts thereof, and

water-soluble or water-dispersible derivatives of acrylic and methacrylic acids, in particular acrylamide, methacrylamide, n-alkyl-substituted acrylamides, 2-hydroxyethyl acrylate, 2-hydroxyethyl methacrylate, hydroxypropyl acrylate, hydroxypropyl methacrylate, a C₁-C₄ alkyl (meth)acrylate and vinyl acetate.

The monomer solution preferably contains as monomers acrylic acid and/or an acrylic acid derivative, particularly preferably at least one salt of acrylic acid and/or acrylamide and very particularly preferably a mixture of acrylic acid, at least one salt of acrylic acid, acrylamide and a salt of 2-acrylamido-2-methylpropanesulfonic acid.

Further preferred monomers are dialkyldiallylammonium chloride, dialkylaminoalkyl (meth)acrylic acid esters and dialkylaminoalkyl (meth)acrylamides, in particular in each case in the form of the salts or in quaternised form. Such compounds preferably include (meth)acrylic acid 2-(trimethylammonio)ethyl ester chloride and (meth)acrylic acid S-(trimethylammonio)propylamide chloride.

The monomer-containing water-in-oil-dispersion is produced by adding the monomer solution to an organic phase which contains a water-in-oil emulsifier. The organic phase used may in principle be any substance known to the person skilled in the art for reversed-phase emulsion polymerisation, preferably aliphatic hydrocarbons.

In a preferred embodiment of this invention, fatty acid esters are used as the organic phase. Esters of linear saturated or unsaturated fatty acids are particularly preferably used, in particular fatty acids with an alkyl chain length of more than 11 carbon atoms, preferably lauric, myristic, palmitic, stearic or oleic acid. Short-chain alcohols, preferably C₁-C₄alcohols are preferably used as the alcohol component. Higher, singly branched alcohols, which may preferably be produced by a Guerbet reaction, are likewise preferably used. Using these substances gives rise to water-in-oil polymer dispersions which exhibit very low daphnia toxicity measured in accordance with OECD Guideline 202.

The fatty acid esters are used alone or preferably mixed with a hydrocarbon or a mixture of hydrocarbons, wherein the hydrocarbon or the mixture of hydrocarbons preferably have a boiling point of less than 200° C. “White oils” from petroleum distillation or ligroin with a boiling range of 150-200° C. are very particularly preferably used for this purpose.

The organic phase is preferably used in a quantity of 20 to 80 wt. %, relative to the quantity of the dispersion. 0.5 to 10 wt. %, relative to the quantity of the dispersion, of at least one oil-soluble emulsifier are added to the organic phase as emulsifier. Water-in-oil (W/O) emulsifiers are preferably used. Sorbitan esters, phthalic acid esters, fatty acid glycerides and ethoxylated derivatives thereof are particularly preferably used in combination with W/O emulsifiers. Polymeric emulsifiers with the trade name Hypermer® (ICI, London, England) are very particularly preferably used.

A residual monomer scavenger is preferably added to the polymer dispersion after completion of the polymerisation. The addition is calculated such that the residual monomer content of the resultant water-in-oil polymer dispersion is less than 1,000 ppm, preferably less than 500 ppm and particularly preferably less than 300 ppm.

For the purposes of the present invention, residual monomer scavengers are substances which modify polymerisable monomers by a chemical reaction in such a manner that they are no longer polymerisable, such that, for the purposes of the present invention, they are no longer monomers. To this end, substances may be used which react with the double bond present in the monomers and/or substances which are capable of initiating an ongoing polymerisation reaction.

Examples of usable residual monomer scavengers which react with the double bond are, for example, reducing agents, preferably

substances from the group of acidic and neutral salts of sulfur-derived acids with an oxidation number of less than VI, preferably sodium dithionite, sodium thiosulfate, sodium sulfite or sodium pyrosulfite, and/or

substances with a hydrogen sulfide group, preferably sodium hydrogensulfide or compounds from the group of thiols, preferably mercaptoethanol, dodecyl mercaptan, thiopropionic acid or salts of thiopropionic acid or thiopropanesulfonic acid or salts of thiopropanesulfonic acid, and/or

substances from the group of amines, preferably from the group of amines with low volatility, preferably diisopropanolamine or aminoethylethanolamine, and/or

substances from the group consisting of Bunte salts, formamidinesulfinic acid, sulfur dioxide, aqueous and organic solutions of sulfur dioxide or thiourea.

The person skilled in the art will recognise that it is also possible to use a mixture of at least two residual monomer scavengers from one or more groups.

The residual monomer content may be reduced by a reinitiated polymerisation reaction by using the above-stated reducing agents alone or in combination with oxidising agents, preferably substances from the group of peroxodisulfates or hydroperoxides, preferably hydrogen peroxide. Further suitable compounds are those which dissociate at elevated temperature to yield free radicals, such as preferably substances from the group of azo compounds, peroxides or peroxodisulfates.

0.01 to 2 wt. % of residual monomer scavengers are preferably added to the polymer dispersion.

Finally, the inverter mixture according to the invention is added to the water-in-oil polymer dispersion in a quantity of preferably 0.5 to 10 wt. %, relative to the quantity of the dispersion.

The water-in-oil polymer dispersion according to the invention contains preferably 10 to 70 wt. %, particularly preferably 20 to 50 wt. % and very particularly preferably 25 to 40 wt. %, of water-soluble and/or water-swellable polymer particles.

The polymer particles preferably have a particle size of less than 2 μm, and particularly preferably a particle size of less than 1 μm.

The water-in-oil polymer dispersions according to the invention containing water-soluble and/or water-swellable polymers are distinguished from such prior art polymer dispersions by having improved environmental impact.

This improved environmental impact makes the polymer dispersions according to the invention particularly suitable from an environmental standpoint for use in the natural environment. In addition, the resultant products exhibit a comparatively low viscosity and relatively short activation times.

The present invention also provides a process for the production of water-in-oil polymer dispersions according to the invention, preferably by phase inversion emulsion polymerisation, preferably using one or more fatty acid esters as the organic phase, wherein, after the polymerisation, an inverter mixture according to the invention is added to the polymer.

The residual monomer scavengers used in the process according to the invention are preferably from the group of acidic and neutral salts of sulfur-derived acids with an oxidation number of less than VI, preferably sodium dithionite, sodium thiosulfate, sodium sulfite or sodium pyrosulfite, and/or substances with a hydrogen sulfide group, preferably sodium hydrogensulfide or compounds from the group of thiols, preferably mercaptoethanol, dodecyl mercaptan, thiopropionic acid or salts of thiopropionic acid or thiopropanesulfonic acid or salts of thiopropanesulfonic acid, and/or substances from the group of amines, preferably from the group of amines with low volatility, and/or substances from the group consisting of Bunte salts, formamidinesulfinic acid, sulfur dioxide, aqueous and organic solutions of sulfur dioxide or thiourea.

The residual monomer scavengers are furthermore preferably used in a quantity of 100 to 20,000 ppm, particularly preferably 200 to 5,000 ppm, very particularly preferably 500 to 3,000 ppm, relative to the dispersion.

Polymerisation is initiated by the addition of polymerisation initiators known to the person skilled in the art. Azo compounds, peroxide compounds or redox catalysts, in each case alone or in a mixture or in combination with one another, are preferably used for this purpose in a quantity of 0.001 to 5 wt. %, relative to the quantity of monomer solution.

Polymerisation is performed adiabatically, isothermally or as combination of an adiabatic and isothermal process.

When the process is performed isothermally, polymerisation is initiated at a specific temperature under reduced pressure, as is, for example, described in EP 228 397 B1. This document is hereby introduced as a reference and is deemed to be part of the disclosure. The reduced pressure is here adjusted such that the volatile substances arising due to the heat of polymerisation, such as water and constituents of the organic phase, are removed by distillation and the temperature may be kept virtually constant. When no further distillate passes over, the polymerisation has come to an end. According to the invention, the above-stated residual monomer scavenger is optionally added to the polymer dispersion after polymerisation.

In a manner similar to the isothermal process, the adiabatic process is initiated at a specific temperature in the range from 0 to 100° C., preferably from 50 to 75° C. Polymerisation is, however, performed at atmospheric pressure without external input of heat until, due to the heat of polymerisation, a maximum final temperature of the dispersion is obtained, said temperature depending on the content of polymerisable material in the dispersion. Once polymerisation has come to an end, the reaction mixture is cooled, during which time the residual monomer scavenger is added.

Polymerisation may furthermore be performed as a combination of an isothermal and an adiabatic process step. Such a process is preferably initially performed isothermally. At a predetermined time, the apparatus is ventilated with inert gas and the polymerisation continued adiabatically up to a specific final temperature. Thereafter, the batch is cooled down to a preselected temperature while being distilled under reduced pressure.

Finally, the polymer dispersion is combined with the inverter mixture according to the invention in a quantity of preferably 0.5 to 10 wt. %, relative to the entire polymer dispersion, wherein the inverter mixture is preferably stirred into the polymer dispersion.

The process according to the invention is simple to perform.

The present invention also provides the use of the water-in-oil polymer dispersions according to the invention as flocculants

for settling solids, in particular in water and process water treatment or waste water treatment and

in the extraction of raw materials, preferably of coal, aluminium and petroleum or as auxiliaries in papermaking and in the sugar industry.

The water-in-oil polymer dispersions according to the invention are furthermore used as thickeners, preferably as thickeners for fire extinguishing water.

The water-in-oil polymer dispersions according to the invention may also be used as supports for agrochemicals, preferably as supports for phytosanitary agents or other biologically active substances, or they are usable as antierosion agents.

### EXAMPLES

The invention is explained below with reference to Examples. These explanations are given merely by way of example and do not restrict the general concept of the invention.

Determination of Viscosities:

Viscosity was measured as shear viscosity with a Brookfield RVT-DVII viscosimeter. The measurement was made with spindle 5 at three different shear rates (1.0, 2.5 and 5.0 rpm). The readings taken are stated as the viscosity in mPa·s at the various shear rates.

Determination of Activation Time

Activation time was determined by introducing the polymer dispersion, which had been combined with the inverter according to the invention, into water. To this end, 27.5 g of the activated dispersion polymer were stirred together with 972.5 g of water by placing a vessel containing the liquids under a Record propeller mixer from Multifix and starting the stirrer motor. Starting from 3000 min⁻¹, the rotational speed was raised to 3300 min⁻¹ and the time until the stirring vortex was no longer visible was measured. This time interval is stated as the activation time in seconds.

Chemicals

Acrylamide and sodium 2-acrylamido-2-methylpropane sulfonate were used as a 50 wt. % aqueous solution and acrylic acid 2-(trimethylammonio)ethyl ester chloride was used as an 80 wt. % aqueous solution. This water content was included in the calculation of the total quantity of water.

Chemical Characterisation of the Raw Materials Used:

Hypermer® 1083: sorbitan monooleate with protective colloid from ICI.

Edenor® MESU: rapeseed oil fatty acid methyl ester from Henkel

Shellsol® D40: mixture of n-, i- and cyclo-aliphatic compounds from Shell

Marlipal® 013: ethoxylated isotridecanol from Condea

Glucopon® 225 DK: C₈-C₁₀ fatty alcohol polyglycoside, 68-72 wt. % in aqueous solution (Henkel)

Imbentin® CMEA: ethoxylated coconut fatty acid monoethanolamide from Kolb, Hedingen, Switzerland

Intrasol® FA: fatty alcohol polyglycol ether from Servo

### Comparative Example 1

1.00 ml of pentasodium diethylenetriamine pentaacetate (58-10 wt. % in H₂O), 2.40 ml of formic acid and 2.63 g of triallylmethylammonium chloride were added to a solution prepared from 288 g of acrylic acid, 99 g of acrylamide, 37.8 g of sodium 2-acrylamido-2-methylpropanesulfonate and 223.20 g of sodium hydroxide in 516.95 g of water. A solution of 45 g of Hypermer® 1083 in 342 g of Edenor® MESU and 136.8 g of Shellsol® D40 was mixed into said mixture. Using a Krupp 3Mix Mixer, the mixture was homogenised to yield a finely divided emulsion and placed in a 2 litre sulfonation flask with a KPG stirrer. After degassing by perfusion with nitrogen, 0.50 g of diethyl-2,2′-azobisisobutyrate were added and the mixture heated to 60° C. Polymerisation began and the temperature was maintained between 60° C. and 100° C. by boiling cooling. The temperature was then reduced to 40° C. A solution of 1.80 g of Na₂SO₃ and 20.70 g of water was then stirred in and the mixture stirred for 60 min at 40° C. 286.8 g of the water-in-oil polymer dispersion were taken and combined with 13.2 g (4.4 wt. %) of Marlipal® O 13/50. The activation time and the various viscosities of the product were determined and are shown Table 1.

TABLE 1
activation with 4.4 wt. % Marlipal ® O 13/50

| | | Solution | Solution | Solution |
|---|---|---|---|---|
| Product | | viscosity | viscosity | viscosity |
| viscosity, | Activation | 1.0 rpm | 2.5 rpm | 5.0 rpm |
| mPa · s | time s | mPa · s | mPa · s | mPa · s |
| 220 | 7 | 53000 | 28300 | 18000 |

### Comparative Example 2

The water-in-oil polymer dispersion was produced as in Comparative Example 1.

286.8 g of the dispersion were taken and combined with 13.2 g (4.4 wt. %) of Glucopon® 225 DK. This resulted in the formation of a flocculent precipitate of the alkylpolyglycoside.

### Example 1

The water-in-oil polymer dispersion was produced as in Comparative Example 1. 286.8 g of the dispersion were taken and combined with 13.2 g (4.4 wt. %) of a mixture of Glucopon® 225 DK and Marlipal® 013/30 in a 1:1 mixing ratio. The characteristics of the product were determined and are shown in Table 2.

TABLE 2
activation with 4.4 wt. % of a mixture of
Glucopon ® 225 DK/Marlipal ® 013/30 (1:1)

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 300 | 30 | 80400 | 40000 | 23600 |

### Example 2

The water-in-oil polymer dispersion was produced as in Example 1. 282 g of the dispersion were taken and combined with 18 g (6 wt. %) of a mixture of Glucopon® 225 DK and Marlipal® 013/30 in a 1:1 mixing ratio. The characteristics of the product were determined and are shown in Table 3.

TABLE 3
activation with 6 wt. % of a mixture of Glucopon ®
225 DK/Marlipal ® 013/30 (1:1)

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 740 | 20 | 66000 | 35200 | 21800 |

### Example 3

1.00 ml of pentasodium diethylenetriamine pentaacetate (58 wt. % in H₂O), 2.40 ml of formic acid and 5.60 g of triallylmethylammonium chloride were added to a solution prepared from 288 g of acrylic acid, 99 g of acrylamide, 37.8 g of sodium 2-acrylamido-2-methylpropanesulfonate and 223.2 g of sodium hydroxide in 452.15 g of water. A solution of 45 g of Hypermer® 1083 in 378 g of Edenor® MESU and 136.8 g of Shellsol® D40 was mixed into said mixture. Using a Krupp 3Mix Mixer, the mixture was homogenised to yield a finely divided emulsion and placed in a 2 litre sulfonation flask with a KPG stirrer and the mixture was heated to 60° C. After degassing by perfusion with nitrogen, 0.50 g of diethyl-2,2′-azobisisobutyrate were added and the mixture heated to 60° C. Polymerisation began and the temperature was maintained between 60° C. and 100° C. by boiling cooling. The temperature was then reduced to 40° C. A solution of 1.80 g of Na₂SO₃ and 20.7 g of water was then stirred in and the mixture stirred for 60 min at 40° C. 282 g of the water-in-oil polymer dispersion were taken and combined with 18 g (6 wt. %) of a mixture of Glucopon® 225 DK and Marlipal® 013/30 in a 1:1 ratio by weight. The activation time and the various viscosities of the product were determined and are shown Table 4.

TABLE 4
activation with 6 wt. % of a mixture of Glucopon ®
225 DK/Marlipal ® 013/30 (1:1) and a modified oil/water
ratio in the dispersion

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 520 | 15 | 74400 | 37800 | 23000 |

### Comparative Example 3

The water-in-oil polymer dispersion was produced as in Comparative Example 1. 286.8 g of the dispersion were taken and 13.2 g of Imbentin® CMEA/020 added. The dispersion became solid as a consequence.

### Example 4

The water-in-oil polymer dispersion was produced as in Comparative Example 1.

286.8 g of the dispersion were taken and 13.2 g (4.4 wt. %) of a mixture of Imbentin® CMEA/020 and Marlipal® 013/30 in the ratios by weight 2:1, 1:1, 1:2 were added. The characteristics of the product were determined and are shown in Table 5.

TABLE 5
activation with 4.4 wt. % of a mixture of
Imbentin ® CMEA/020/Marlipal ® 013/30

| Imbentin ®/ | | | Solution | Solution | Solution |
|---|---|---|---|---|---|
| Marlipal | Product | | viscosity | viscosity | viscosity |
| mixing | viscosity | Activation | 1.0 rpm | 2.5 rpm | 5.0 rpm |
| ratio | mPa · s | time s | mPa · s | mPa · s | mPa · s |
| 2:1 | 40000 | —¹⁾ | ¹⁾ | ¹⁾ | ¹⁾ |
| 1:1 | 20400 | 30 | 169000 | 86800 | 51000 |
| 1:2 | 180 | 120 | 66000 | 35200 | 21800 |

¹⁾product characteristics could not be determined due to elevated product viscosity

### Example 5

The water-in-oil polymer dispersion was produced as in Comparative Example 1. 286.8 g of the dispersion were taken and combined with 13.2 g (4.4 wt. %) of a mixture of Imbentin® CMEA/130 and Marlipal 013/30 in a 10:1 ratio by weight. The characteristics of the product were determined and are shown in Table 6.

TABLE 6
activation with 4.4 wt. % of a mixture of
Imbentin ® CMEA/130/Marlipal ® 013/30

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 3200 | 20 | 98000 | 51200 | 32000 |

### Example 6

The water-in-oil polymer dispersion was produced as in Comparative Example 1. 286.8 g of the dispersion were taken and 13.2 g (4.4 wt. %) of a mixture of Imbentin® CMEA/130 and Marlipal 013/30 were added in the ratios by weight 2:1, 1:1, 1:2. The characteristics of the product were determined and are shown in Table 7.

TABLE 7
activation with 4.4% of a mixture of Imbentin ®
CMEA/130 and Marlipal ® 013/30

| Imbentin ®/ | | | Solution | Solution | Solution |
|---|---|---|---|---|---|
| Marlipal | Product | | viscosity | viscosity | viscosity |
| mixing | viscosity | Activation | 1.0 rpm | 2.5 rpm | 5.0 rpm |
| ratio | mPa · s | time s | mPa · s | mPa · s | mPa · s |
| 2:1 | 1000 | 30 | 83000 | 44400 | 28000 |
| 1:1 | 420 | 40 | 114000 | 58400 | 36200 |
| 1:2 | 220 | 50 | 103000 | 54400 | 33600 |

### Example 7

The water-in-oil polymer dispersion was produced as in Comparative Example 1. 286.8 g of the dispersion were taken and 13.2 g (4.4 wt. %) of a mixture of Imbentin® CMEA/130 and Marlipal® 013/80 in the ratios by weight 2:1, 1:1, 1:2 were added. The characteristics of the product were determined and are shown in Table 8.

TABLE 8
activation with 4.4% of a mixture of Imbentin ®
CMEA/130 and Marlipal ® 013/80

| Imbentin ®/ | | | Solution | Solution | Solution |
|---|---|---|---|---|---|
| Marlipal | Product | | viscosity | viscosity | viscosity |
| mixing | viscosity | Activation | 1.0 rpm | 2.5 rpm | 5.0 rpm |
| ratio | mPa · s | time s | mPa · s | mPa · s | mPa · s |
| 2:1 | 2000 | 55 | 83000 | 44400 | 30000 |
| 1:1 | 1500 | 30 | 92000 | 48000 | 30000 |
| 1:2 | 1300 | 40 | 81000 | 43200 | 27000 |

### Example 8

The water-in-oil polymer dispersion was produced as in 5 Example 3. 285 g of the dispersion were taken and mixed with 15 g (5 wt. %) of a mixture of Imbentin® CMEA/020 and Marlipal® 013/80 in a 1:2 ratio by weight. The characteristics of the product were determined and are shown in Table 9.

TABLE 9
activation with 5 wt. % of a mixture of Imbertin ®
CMEA/020 and Marlipal ® 013/80 and a modified oil/water
ratio in the emulsion

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 164 | 10 | 105000 | 54400 | 32800 |

### Example 9

The water-in-oil polymer dispersion was produced as in Comparative Example 1, wherein the composition of the aqueous and the organic phase was modified as stated below. 0.70 g of pentasodium diethylenetriamine pentaacetate, 0.17 g of formic acid and 0.10 g of technical hydrochloric acid were added to a solution prepared from 114.0 g of acrylamide, 384.3 g of water and 341.4 g of acrylic acid [2-trimethylchloroamino]ethyl ester. A solution of 22.76 g of isohexadecane, 20.30 g of Hypermer® 2296 and 12.90 g of Intrasol FA 1218/15 was mixed into said mixture. Using a Krupp 3Mix Mixer, the mixture was homogenised to yield a finely divided emulsion and placed in a 2 litre sulfonation flask with a KPG stirrer. 0.092 g of azoisobutyrodinitrile in 12.0 g of isohexadecane were used as the catalyst. Production of the dispersion polymer otherwise proceeded as in Comparative Example 1. 286.8 g of the dispersion were taken and 13.2 g (4.4 wt. %) of Marlipal® 013/50 were added.

The characteristics of the product were determined and are shown in Table 10.

TABLE 10
activation with 4.4 wt. % Marlipal ® 013/50

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 3300 | 15-18 | 38400 | 18900 | 11200 |

### Comparative Example 4

The water-in-oil polymer dispersion was produced as in Example 8.

286.8 g of the dispersion were taken and 13.2 g (4.4 wt. %) of Glucopon® 225 DK were added.

This resulted in agglomeration of the activator, such that the emulsion could not be homogenised.

### Example 10

The water-in-oil polymer dispersion was produced as in Example 8. 286.8 g of the dispersion were taken and mixed with 13.2 g (4.4 wt. %) of a mixture of Glucopon 225 DK and Marlipal® 013/30 in a 1:1 ratio by weight. The characteristics of the product were determined and are shown in Table 11.

TABLE 11
activation with 4.4 wt. % of a mixture of
Glucopon ® 225 DK and Marlipal ® 013/30

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 8200 | 6 | 38400 | 19500 | 11800 |

### Comparative Example 5

The water-in-oil polymer dispersion was produced as in Example 8. 286.8 g of the dispersion were taken and 13.2 g (4.4 wt. %) of Imbentin® CMEA/130 were added. The characteristics of the product were determined and are shown in Table 12. Due to severe agglomeration, only the product viscosity and the activation time could be determined.

TABLE 12
activation with 4.4 wt. % Imbentin ® CMEA/130

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 16500 | 120 | _2 | _2 | _2 |

²due to agglomeration, it proved impossible to determine all characteristics

### Example 11

The water-in-oil polymer dispersion was produced as in Example 8. 286.8 g of the dispersion were taken and 13.2 g (4.4 wt. %) of a mixture of Imbentin® CMEA/130 and Marlipal 013/30 were added in a 1:1 ratio. The characteristics of the product were determined and are shown in Table 13.

TABLE 13
activation with 4.4 wt. % of a mixture of
Imbentin ® CMEA/130/Marlipal ® 013/30 (1:1)

| | | Solution | Solution | Solution |
|---|---|---|---|---|
| Product | | viscosity | viscosity | viscosity |
| viscosity | Activation | 1.0 rpm | 2.5 rpm | 5.0 rpm |
| mPa · s | time s | mPa · s | mPa · s | mPa · s |
| 1800 | 20-22 | 36000 | 18600 | 10900 |

1: An inverter mixture characterised in that it contains at least one ethoxylated fatty alcohol and at least one ethoxylated fatty acid mono- and/or dialkanolamide or at least one ethoxylated fatty alcohol and at least one alkylpolyglycoside.

2: An inverter mixture according to claim 1, characterised in that the ethoxylated fatty alcohol is present in the ratio 1:10 to 10:1, preferably in the ratio 1:3 to 3:1, to the ethoxylated fatty acid mono- and/or dialkanolamide or the alkylpolyglycoside.

3: Use of an inverter mixture according to one of claims 1 or 2 as an addition to water-in-oil polymer dispersions.

4: Use according to claim 3, characterised in that the inverter mixture is added to the water-in-oil polymer dispersion in a quantity of 0.5 to 10 wt. %, preferably 2 to 8 wt. %, particularly preferably 3-6 wt. %, relative to the total quantity of water-in-oil polymer dispersion.

5: Use according to claim 3 or 4, characterised in that a water-in-oil polymer dispersion is converted into an oil-in-water polymer dispersion by the addition of large quantities of water.

6: A water-in-oil polymer dispersion consisting of a continuous, virtually water-immiscible organic phase and, finely dispersed therein, water-soluble and/or water-swellable polymers and optionally auxiliary substances, characterised in that said dispersion contains an inverter mixture according to one of claims 1 or 2.

7: A water-in-oil polymer dispersion according to claim 6, characterised in that it consists of:
A) 10 to 70 wt. %, preferably 20 to 50 wt. %, particularly preferably 25 to 35 wt. %, of a water-soluble and/or water-swellable polymer,
B) 20 to 80 wt. % of an organic phase,
C) 0.5 to 10 wt. % of a water-in-oil emulsifier,
D) optionally 0.01-2 wt. % of a residual monomer scavenger,
E) 0.5 to 10 wt. % of the inverter mixture, and
F) water to make up to 100 wt. %.

8: A water-in-oil polymer dispersion according to one of claims 6 or 7, characterised in that the polymer is based on acrylic acid and/or at least one acrylic acid derivative, preferably a salt of acrylic acid, a salt of 2-acrylamido-2-methylpropanesulfonic acid, acrylamide, (meth)acrylic acid 2-(trimethylammonio)ethyl ester chloride and/or (meth)acrylic acid 3-(trimethylammonio)propylamide chloride.

9: A process for the production of a water-in-oil polymer dispersion according to one of claims 6 to 8, preferably by reversed-phase emulsion polymerisation, characterised in that, after the polymerisation, an inverter mixture is added to the polymer.

10: Use of the water-in-oil polymer dispersions according to one of claims 6 to 8 as flocculants for settling solids, in particular in water and process water treatment or waste water treatment, in the extraction of raw materials, preferably of coal, aluminium and petroleum or as auxiliaries in papermaking and in the sugar industry.

11: Use of the water-in-oil polymer dispersions according to one of claims 6 to 8 as thickeners, preferably as thickeners for fire extinguishing water.

12: Use of the water-in-oil polymer dispersions according to one of claims 6 to 8 as supports for agrochemicals, preferably as supports for phytosanitary agents or other biologically active substances.

13: Use of the water-in-oil polymer dispersions according to one of claims 6 to 8 as antierosion agents.
